(19) United States
(12) Patent Application Publication
(10) Pub. No.: US 2006/0182490 A1
(43) Pub. Date: Aug. 17, 2006

(54) Double Aperture Sheet Lifter

(76) Inventor: Pedro H. Albuquerque, Laredo, TX (US)

Correspondence Address: Pedro H. Albuquerque, 113 Lindenwood Dr., Laredo, TX, 78041-2801, US

(21) Appl. No.: 10/906,297

(22) Filed: Feb. 13, 2005

(51) Int. Cl. B42F 13/00

(52) U.S. Cl. 402/79

(57) ABSTRACT

The “double aperture sheet lifter” improves on current commercial sheet lifter models. Its function is to facilitate the handling of punched paper sheets in ring binders. It improves on existing models by using a double row of apertures instead of one.

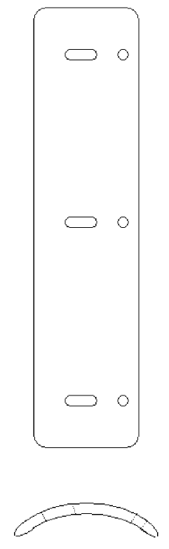

The “double aperture sheet lifter” improves on existing sheet lifter models. Its function is to facilitate the handling of punched paper pages in ring binders.

The “double aperture sheet lifter” improves on existing models by reducing the handling stress on punched holes, and by decreasing the amount of material used in production.

The “double aperture sheet lifter” differentiates itself from the existing models by having two rows of apertures instead of one. While existing sheet lifters are attached to the ring binder by one set of apertures, the “double aperture sheet lifter” is attached through two sets of apertures. This configuration increases stability of the sheet lifter blade and improves the contact angle with the paper pages, reducing the stress on the punched holes. The improvement is particularly significant in the case of bulky ring binders. The improvement in stability implies that less material is needed in the production of the blades, leading to a reduction in production cost.

The “double aperture sheet lifter” consists of a curved or angled hardened blade, made of any suitable material (plastic, metal etc.). The rectangular blade typical dimensions are 10.5 in. length and 2.5 in. wide, but will vary according to the binder dimensions. The blade is curved to facilitate the attachment to the binder and to guarantee the best contact angle with the paper pages. The curvature will vary according to the binder dimension. A first row of round holes or slits is made on one of the long sides of the rectangle, being the first to be attached to the binder rings. A second row of slits is made on the other long side of the rectangle, being the second to be attached to the binder rings. The blade will therefore acquire much better stability and handling due to the double aperture attachment.

What is claimed is:

1. The “double aperture sheet lifter” differentiates itself from existing ring binder sheet lifters by the use of a double row of apertures instead of just one. The benefits of this new arrangement are: (1) it reduces the stress on punched holes by improving the contact angle with the paper pages, and (2) it decreases the amount of material used in production and consequently the production cost, due to the improved stability and handling of the sheet lifter blade.
